(19) United States
(12) Patent Application Publication
(10) Pub. No.: US 2009/0272050 A1
(43) Pub. Date: Nov. 5, 2009

(54) WINDOW SYSTEM FOR HIGH FLOORS

(75) Inventor: Do-Young Lee, Cheongju-si (KR)

Correspondence Address: CANTOR COLBURN, LLP, 20 Church Street, 22nd Floor, Hartford, CT, 06103, US

(73) Assignee: LG CHEM, LTD., Seoul (KR)

(21) Appl. No.: 11/574,462

(22) PCT Filed: Sep. 27, 2006
(86) PCT No.: PCT/KR06/03834

§ 371 Date: Feb. 28, 2007

(30) Foreign Application Priority Data
Nov. 14, 2005 (KR) 10-2005-0108459
Dec. 30, 2005 (KR) 10-2005-0134709
Feb. 16, 2006 (KR) 10-2006-0015297
Jun. 23, 2006 (KR) 10-2006-0056931

(51) Int. Cl. E06B 3/66

(52) U.S. Cl. 52/204.62

(57) ABSTRACT

A window system for high floors installed in a window opening defined through a wall comprises a main frame, which has a thickness which corresponds to the thickness of the wall when measured in forward and rearward directions, and is fitted into and secured in the window opening of the wall; and at least one division frame coupled to the main frame in a vertical and/or horizontal direction to divide the window space defined in the main frame into a plurality of window spaces, and depressed indoors from the front outdoor surface of the main frame. The window system has sufficient wind resistance, improves the aesthetic outer appearance of a building including the window system, decreases the numbers of component parts and required work processes, is easy to manufacture and install, reduces costs, allows easy coupling of a window sash, ensures watertightness, prevents corrosion, and is easy and safe to wash.

This application claims the benefit of the filing date of Korean Patent Application No. 10-2005-0108549 filed on Nov. 14, 2005, 10-2005-0134709 filed on Dec. 30, 2005, 10-2006-0015297 filed on Feb. 16, 2006 and 10-2006-0056931 filed on Jun. 23, 2006 in the Korean Intellectual Property Office, the disclosure of which is incorporated herein in its entirety by reference.

### TECHNICAL FIELD

The present invention relates, in general, to a window system for high floors, and more particularly, to a window system for high floors in which the structure of a window frame is improved.

### BACKGROUND ART

As is generally known in the art, a window system installed in a building must be constructed in consideration of interior and exterior aesthetic appearances, the safety of occupants, adequate ventilation, convenience of installation, etc. Specifically, a window system installed in a tall building must also be constructed in consideration of ability to withstand strong wind.

FIGS. 1 through 2 illustrate an example of a conventional window system 101 for high floors. Referring to these drawings, the conventional window system 101 for high floors includes a window frame 110 which is installed in an opening 105 defined through a wall 103 and forms a plurality of window spaces, an openable window 130 and/or a fixed window 140 which is installed in each of the window spaces of the window frame 110, and a finishing member 120 which is joined to the exposed region A of the wall 103.

The window frame 110 is composed of a main frame 111 having the shape of a quadrangular framework and a perimeter corresponding to that of the opening 105 defined in the wall 103, and at least one division frame 113 which is coupled to the main frame 111 in a vertical and/or horizontal direction to form the plurality of window spaces.

The thickness t1 of the main frame 111, which is measured in the forward and rearward directions, is less than the thickness T of the wall 103. Due to this fact, an exposed region A is present on the surface of the wall 103 which defines the opening 105. The exposed region A has a thickness which is determined by subtracting the thickness t1 of the main frame 111 from the thickness T of the wall 103. The exposed region A is finished using the finishing member 120 in consideration of the interior design. The main frame 111 has a hollow part 111a, and a metallic reinforcing member 111b is fitted into the hollow part 111a in order to increase the strength and wind resistance of the window frame 110.

The division frame 113 is composed of an inside division frame part 115 which is installed in the main frame 111, and an outside reinforcing frame part 117 which is formed to be integral with the inside division frame part 115 and projects in the direction of the outdoors when viewed from the outdoor side surface of the main frame 111. At this time, each of the inside division frame part 115 and the outside reinforcing frame part 117 has an independent hollow part 113a, and, as in the case of the main frame 111, a metallic reinforcing member 113b is fitted into the hollow part 113a in order to increase the strength and wind resistance of the window frame 110.

Due to the fact that both lengthwise ends of the inside division frame part 115 are coupled to the main frame 111 and both lengthwise ends of the outside reinforcing frame part 117 are embedded in the wall 103, the division frame 113 divides the window space defined in the main frame 111 into the plurality of window spaces. The openable window 130 and/or the fixed window 140 is installed in each of the window spaces divided in this way.

However, in the conventional window system for high floors constructed as mentioned above, since the outside reinforcing frame part 117 of the division frame 113 projects in the outdoor direction, the aesthetic appearance of a building having this window system is deteriorated.

Further, due to the fact that the metallic reinforcing member 113b is fitted into the hollow part 113a of each of the inside division frame part 115 and the outside reinforcing frame part 117 of the division frame 113, and the exposed region A of the wall 103 must be finished using the separate finishing member 120, the numbers of component parts and required work processes and material costs are increased.

Specifically, because the outside reinforcing frame part 117 of the division frame 113 projects out of the main frame 111, in order to couple the division frame 113 to the main frame 111, boundary regions between the inside division frame part 115 and the outside reinforcing frame part 117 at both ends of the division frame 113 must be partially removed to allow the main frame 111 to be fitted into the removed portions. Due to this fact, it is difficult to manufacture the window system 101, and the number of manufacturing processes and the manufacturing cost are increased.

Also, when installing the window system 101 in the wall 103 of the building, since the outside reinforcing frame part 117 of the division frame 113, which projects out of the main frame 111, is embedded into the wall 103 or is exposed to the outside, it is difficult to install the window system 101. Further, even after installation of the window system 101, a problem may occur in which rainwater can leak into the gap between the wall 103 and the outside reinforcing frame part 117. If the leaked rainwater is introduced into the indoor space, watertightness is compromised.

In particular, if the leakage of rainwater occurs, the window system 101 may corrode, thus shortening the lifetime of the window system 101, and rust produced due to the corrosion can stain the surface of the wall 103, whereby the outer appearance of the building can be significantly deteriorated.

Besides, since the outside reinforcing frame part 117 of the division frame 113 projects out of the main frame 111 in the outdoor direction, it is inconvenient and dangerous to wash the window system 101 from the outside.

Moreover, in the conventional window system for high floors, since the outside reinforcing frame part 117 of the division frame 113 projects in the outdoor direction, the thickness in the forward and rearward directions of the window space defined between the main frame 111 and the division frame 113 corresponds to the thickness in the forward and rearward directions of the inside division frame part 115 of the division frame 113. Due to this fact, a separate window sash 11a for installation of the openable window 130 and/or the fixed window 140 must be provided, and it is difficult to couple the window sash 11a to the window frame 110. As a result, the number of manufacturing and installation processes and costs are increased.

### DISCLOSURE

### Technical Problem

Accordingly, the present invention has been made in an effort to solve the problems occurring in the related art, and an object of the present invention is to provide a window system for high floors which has sufficient wind resistance, improves the aesthetic outer appearance of a building having the window system, decreases the numbers of component parts and required work processes, is easy to manufacture and install, and reduces costs.

Another object of the present invention is to provide a window system for high floors which allows easy coupling of a window sash, ensures watertightness, prevents corrosion, and is easy and safe to wash.

### Technical Solution

In order to achieve the above object, according to one aspect of the present invention, there is provided a window system for high floors installed in an opening defined through a wall, comprising a main frame having a thickness which corresponds to the thickness of the wall when measured in forward and rearward directions, and fitted into and secured in the opening of the wall; and at least one division frame coupled to the main frame in a vertical and/or horizontal direction to divide a window space defined in the main frame into a plurality of window spaces, and depressed indoors from the front outdoor surface of the main frame.

According to another aspect of the present invention, front outdoor and rear indoor surfaces of the main frame are flush with front outdoor and rear indoor surfaces, respectively, of the wall.

According to another aspect of the present invention, the thickness of the division frame is the same as or less than the thickness of the main frame when measured in the forward and rearward directions.

According to another aspect of the present invention, the front outdoor surface of the division frame is flush with or is depressed inwards from the front outdoor surface of the main frame.

According to another aspect of the present invention, the main frame and the division frame are formed of synthetic resin.

According to another aspect of the present invention, each of the main frame and the division frame has a hollow part, and a single metallic reinforcing member is fitted into the hollow part.

According to another aspect of the present invention, a bent coupling portion is formed on one end of the metallic reinforcing member, which is fitted into the division frame in a coupling region between the main frame and the division frame and/or between division frames; and the bent coupling portion and one surface of the metallic reinforcing member fitted into the main frame and/or the division frame, which is adjacent to the bent coupling portion, are coupled to each other by screws or bolts.

According to another aspect of the present invention, a coupling piece having support parts to be brought into close contact with respective adjacent frames is provided in a coupling region between the main frame and the division frame and/or between division frames; and the support parts of the coupling piece are coupled to the respective frames with screws or bolts.

According to still another aspect of the present invention, a window sash, in which an openable window and/or a fixed window is installed, is integrally coupled in the window space.

According to a still further aspect of the present invention, the openable window is opened and closed by being tilted and/or turned.

### DESCRIPTION OF DRAWINGS

The above objects, and other features and advantages of the present invention will become more apparent after a reading of the following detailed description when taken in conjunction with the drawings, in which:

FIG. 1 is a front view illustrating the installed state of a conventional window system for high floors;

FIG. 2 is a transverse cross-sectional view of the conventional window system for high floors, taken along the line II-II of FIG. 1;

FIG. 3 is a partial exploded perspective view of the conventional window system for high floors shown in FIG. 2;

FIG. 4 is a front view illustrating the installed state of a window system for high floors in accordance with an embodiment of the present invention;

FIG. 5 is a partial exploded perspective view of the window system for high floors in accordance with the embodiment of the present invention, taken along the line V-V of FIG. 4;

FIG. 6 is a transverse cross-sectional view of the window system for high floors in accordance with the embodiment of the present invention, taken along the line V-V of FIG. 4; and

FIG. 7 is a partial perspective view illustrating the frame coupling region shown in FIGS. 4 through 6.

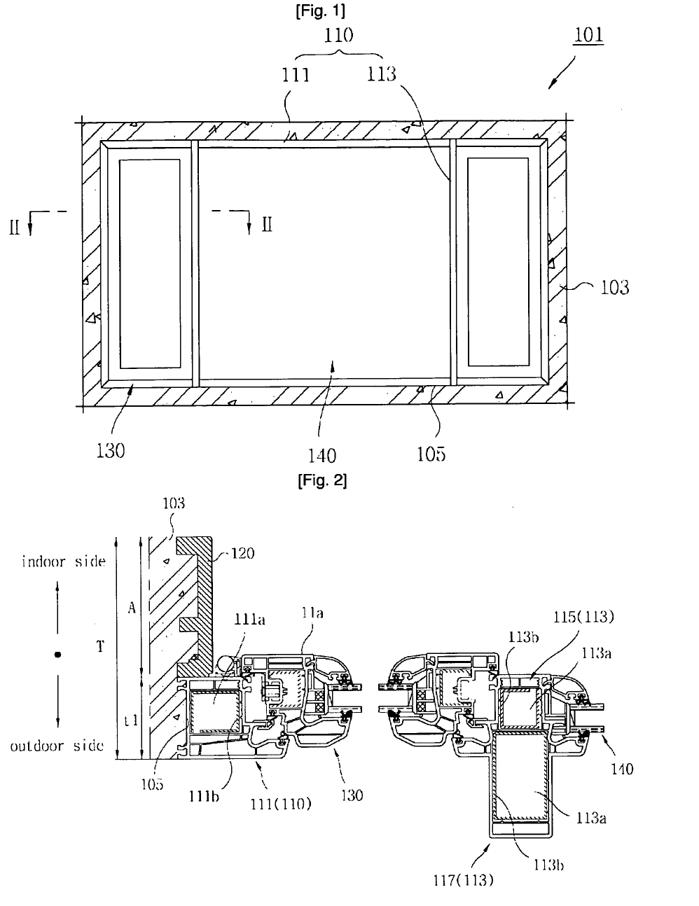

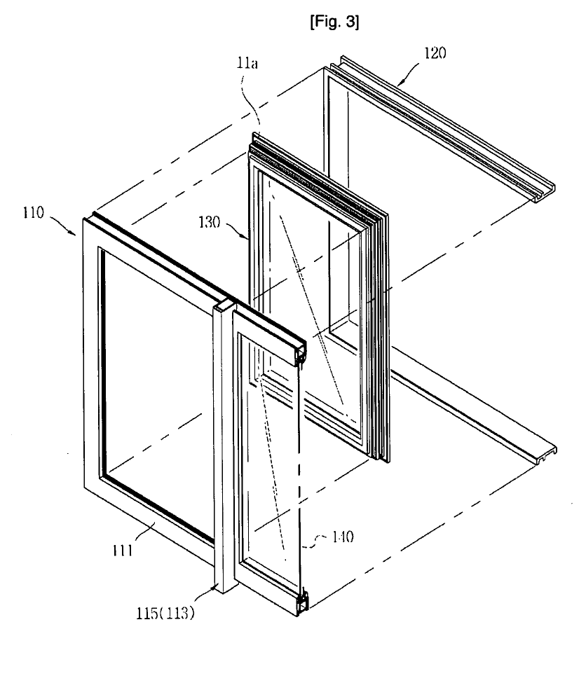

### BEST MODE

Reference will now be made in greater detail to a preferred embodiment of the invention, an example of which is illustrated in the accompanying drawings. Wherever possible, the same reference numerals will be used throughout the drawings and the description to refer to the same or like parts.

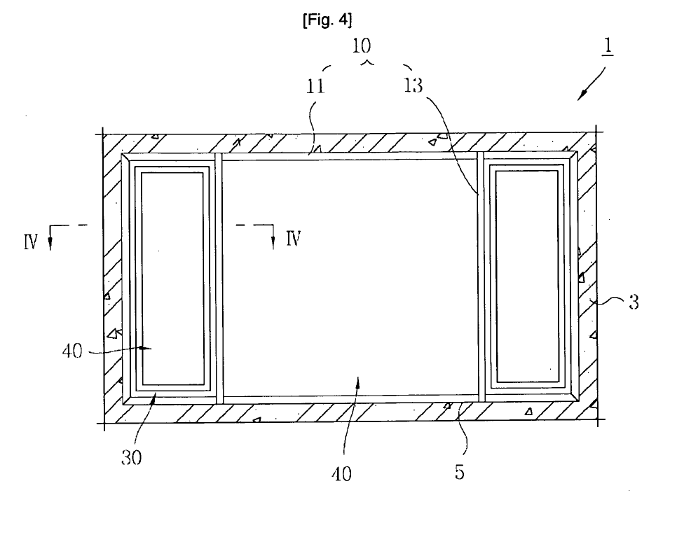

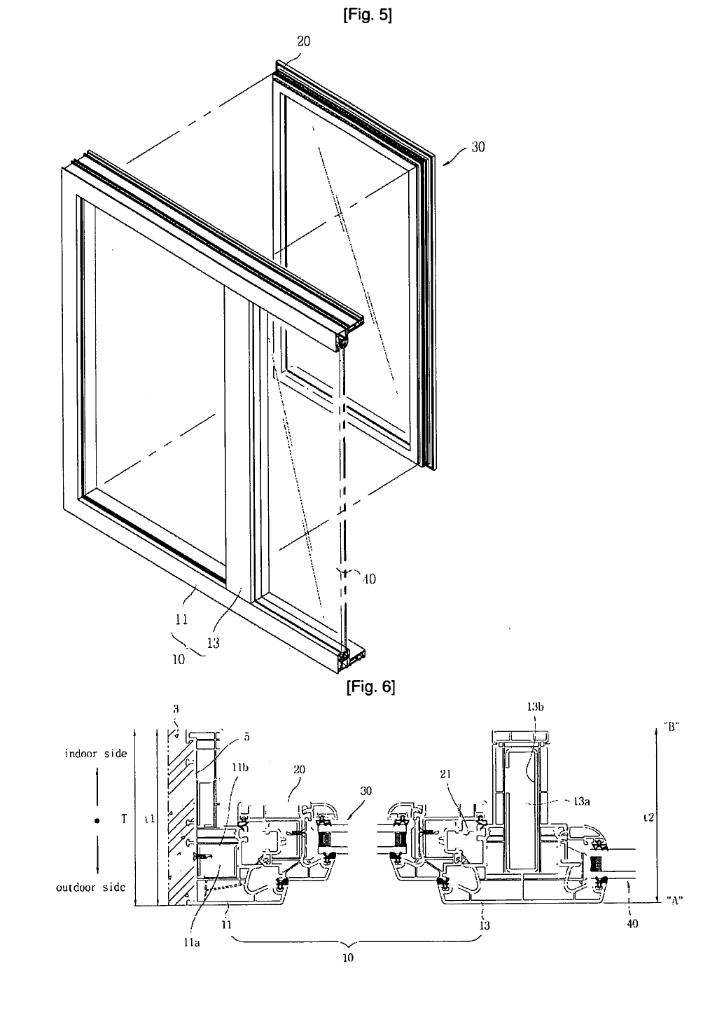

FIG. 4 is a front view illustrating the installed state of a window system for high floors in accordance with an embodiment of the present invention, FIG. 5 is a partial exploded perspective view of the window system for high floors in accordance with the embodiment of the present invention, taken around the line V-V of FIG. 4, and FIG. 6 is a transverse cross-sectional view of the window system for high floors in accordance with the embodiment of the present invention, taken along the line V-V of FIG. 4. Referring to these drawings, the window system 1 for high floors in accordance with the embodiment of the present invention includes a window frame 10 for defining a plurality of window spaces, and a window sash 20 which is fitted into at least one of the window spaces of the window frame 10.

The window frame 10 is composed of a main frame 11 which possesses the shape of a frame and is secured to the inner surface of the wall 3 defining a window opening 5, and at least one division frame 13 which defines a plurality of window spaces in the main frame 11.

The main frame 11 has a thickness t1 which is measured in forward and rearward directions and corresponds to the thickness T of the wall 3. The main frame 11 is coupled to the inner surface of the wall 3 which defines the window opening 5, such that the front outdoor and rear indoor surfaces of the main frame 11 are flush (that is, when viewed in a cross-section, arranged in line) with the front outdoor and rear indoor surfaces, respectively, of the wall 3. Due to this fact, since the entire inner surface of the wall 3, which defines the window opening 5, is covered by the main frame 11, it is possible to realize an aesthetically appealing interior appearance without using a separate finishing member, and the numbers of component parts and required work processes can be decreased.

The main frame 11 may be formed of metallic material, synthetic resin, etc. It is preferable to form the main frame 11 using synthetic resin in consideration of heat insulation performance, ease of manufacture, and cost. In the case of forming the main frame 11 using synthetic resin, it is preferred that a hollow part 11a be defined in the main frame 11 and that a single metallic reinforcing member 11b be fitted into the hollow part 11a to increase the strength and wind resistance of the window frame 10.

The division frame 13 is located in the main frame 11 in a vertical and/or horizontal direction to divide the window space defined in the main frame 11 into the plurality of window spaces. The thickness t2 of the division frame 13 measured in the forward and rearward directions is the same as or less than the thickness t1 of the main frame 11 measured in the forward and rearward directions. Both ends of the division frame 13 are coupled to the inner surface portions of the main frame 11, which face each other. Here, the thickness t2 of the division frame 13 measured in the forward and rearward directions does not exceed the thickness t1 of the main frame 11 measured in the forward and rearward directions. That is to say, the front outdoor surface of the division frame 13 is flush with or is depressed in an indoor direction from the front outdoor surfaces of the wall 3 and the main frame 11. Due to this fact, because the division frame 13 does not project out of the wall 3 or the main frame 11, the outer appearance of a building having the window system 1 is not deteriorated. Further, since the thickness t2 of the division frame 13 measured in the forward and rearward directions substantially corresponds to the thickness t1 of the main frame 11 measured in the forward and rearward directions, the division frame 13 has sufficient strength, wind resistance, and rigidity.

Here, like the main frame 11, the division frame 13 can be formed of metallic material, synthetic resin, etc. It is preferable to form the division frame 13 from synthetic resin in consideration of heat insulation performance, ease of molding, and cost. In the case where the division frame 13 is formed from synthetic resin, it is preferred that a single hollow part 13a be defined in the division frame 13 and that a single metallic reinforcing member 13b be fitted into the hollow part 13a to increase the strength and wind resistance of the window frame 10. Therefore, because the use of the single metallic reinforcing member 13b decreases the number of processes of fitting metallic reinforcing members 13b in the course of manufacturing the window system 1, the numbers of component parts and required work processes can be decreased.

The division frame 13 may comprise a single frame, and is coupled to the inner surface of the main frame 11 in the vertical or horizontal direction to divide the window space of the main frame 11 into the plurality of window spaces. Alternatively, the division frame 13 may comprise a plurality of frames which are coupled with one another to be crossed in the vertical and horizontal directions to divide the window space of the main frame 11 into the plurality of window spaces.

The coupling of the main frame 11 and the division frame 13 and/or the coupling of the division frames 13 in a crossing region is implemented by securely fastening the metallic reinforcing members fitted into the respective frames using screws, bolts, or various locking elements or structures. In the case where the main frame 11 and the division frame 13 are formed of metallic material, these frames can be directly coupled to each other.

For example, while not shown in the drawings, bent coupling portions can be formed on both ends of the metallic reinforcing member 13b of the division frame 13, which abut the inner surface portions of the main frame 11, which face each other, and the corresponding portion of the metallic reinforcing member 11b of the main frame 11 and each bent coupling portion of the metallic reinforcing member 13b of the division frame 13, which are brought into contact with each other, can be securely coupled to each other using coupling elements such as screws, bolts, etc. At this time, the coupling elements are not exposed to the outside. This coupling method can also be employed in a region where the division frames 13 cross each other.

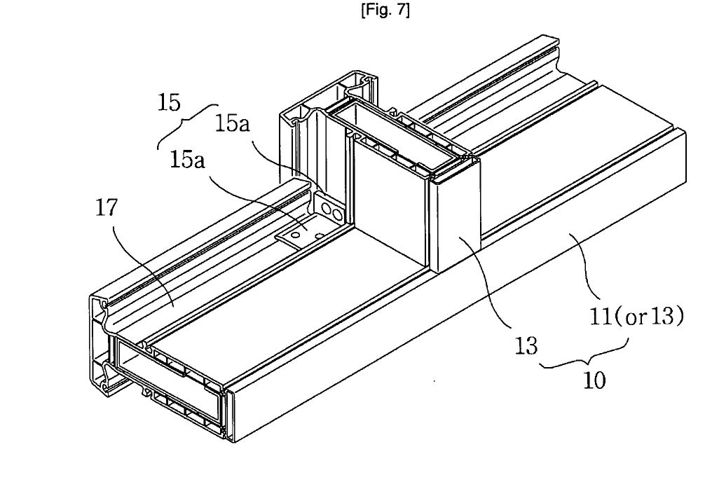

Also, in another example as shown in FIG. 7, in a coupling region between the main frame 11 and the division frame 13 and/or between division frames 13, a separate coupling piece 15, which has support parts 15a to be brought into close contact with respective adjacent frames, is provided, and the support parts 15a of the coupling piece 15 are locked to the respective frames using screws, bolts, etc., so that the respective frames can be securely coupled to each other. In this case, by defining coupling piece installation grooves 17 on the surfaces of the main frame 11 and the division frame 13 in the installation region of the coupling piece 15 and by causing the installation region of the coupling piece 15 to be covered by the window sash 20, the coupling piece 15 is not exposed to the outside.

Meanwhile, the window sash 20 is used to install openable windows 30 and/or fixed windows 40 in the plurality of window spaces defined in the window frame 10. Because the division frame 13 which defines the window space for installation of the window sash 20 is depressed inwards, sufficient installation space to install the window sash is secured. Due to this fact, the window sash 20 can be installed integrally with the main frame 11 and/or the division frame 13 in the corresponding window space of the window frame 10, and even when the window sash 20 is separately provided, sufficient installation space is secured, thus installation work can be conducted in an easy manner, and costs incurred through the manufacture and installation procedures of the window system 1 can be reduced. Here, it is preferred that the openable window 30 installed in the window sash 20 be openable and closable by being tilted and/or turned. A coupling piece accommodating part 21, which corresponds to the coupling piece installation groove 17 of each frame, is defined on the outer peripheral surface of the window sash 20. Due to this fact, the coupling piece 15 for securely coupling the respective frames is not exposed to the outside, and the outer appearance of the window system 1 is not deteriorated.

As described above, in the window system for high floors according to the present invention, since the division frame does not project out of the main frame in the outdoor direction, the window system can maintain sufficient wind resistance, and improve the aesthetic outer appearance of a building including the window system.

Further, in the present invention, a single metallic reinforcing member is fitted into the division frame, and the main frame covers the entire inner surface of the wall which defines the opening, thus obviating the need for a separate finishing member. Due to these facts, the numbers of component parts and required work processes are decreased and material costs are reduced.

In particular, because the division frame can be coupled to the main frame without additionally processing the division frame, it is easy to manufacture the window system, and the number of manufacturing processes and the manufacturing cost are decreased.

Also, since the installation of the window system is completed only by fitting the outer peripheral surface of the main frame into the opening, the window system can be easily installed, and, since rainwater does not leak into the indoor space after installation, watertightness is ensured. Therefore, because corrosion of the window system is prevented, the lifetime of the window system is lengthened, and rust is not produced thus the appearance of the outer wall is not deteriorated.

Moreover, due to the fact that the division frame is depressed in the indoor direction from the front outdoor surface of the main frame, the window system can be conveniently and safely washed.

Furthermore, since the division frame is depressed indoors, it is possible to form the window sash integrally with the main frame and/or the division frame in the window space of the window frame, and even when a separate window sash is provided, sufficient installation space is secured to ease the installation work. Due to these facts, it is possible to reduce the costs incurred through the manufacture and installation procedures of the window system.

### INDUSTRIAL APPLICABILITY

As is apparent from the above description, the window system for high floors according to the present invention provides advantages in that the window system has sufficient wind resistance, improves the aesthetic outer appearance of a building including the window system, decreases the numbers of component parts and required work processes, is easy to manufacture and install, and reduces costs.

Further, the window system for high floors according to the present invention allows easy coupling of a window sash, ensures watertightness, prevents corrosion, and is easy and safe to wash.

In the drawings and specification, typical preferred embodiments of the invention have been disclosed, and although specific terms are employed, they are used in a generic and descriptive sense only and are not for the purposes of limitation, the scope of the invention being set forth in the following claims.

1. A window system for high floors installed in a window opening defined through a wall, comprising:
a main frame having a thickness which corresponds to a thickness of the wall when measured in forward and rearward directions, and fitted into and secured in the window opening of the wall; and
at least one division frame coupled to the main frame in a vertical and/or horizontal direction to divide a window space defined in the main frame into a plurality of window spaces, and depressed indoors from a front outdoor surface of the main frame.

2. The window system as set forth in claim 1, wherein front outdoor and rear indoor surfaces of the main frame are flush with front outdoor and rear indoor surfaces, respectively, of the wall.

3. The window system as set forth in claim 2, wherein a thickness of the division frame is the same as or less than a thickness of the main frame when measured in the forward and rearward directions.

4. The window system as set forth in claim 3, wherein a front outdoor surface of the division frame is flush with or is depressed indoors from the front outdoor surface of the main frame.

5. The window system as set forth in claim 4, wherein the main frame and the division frame are formed of synthetic resin.

6. The window system as set forth in claim 5, wherein each of the main frame and the division frame has a hollow part, and a single metallic reinforcing member is fitted into the hollow part.

7. The window system as set forth in claim 6, wherein a bent coupling portion is formed on an end of the metallic reinforcing member which is fitted into the division frame in a coupling region between the main frame and the division frame and/or between division frames; and the bent coupling portion and one surface of the metallic reinforcing member fitted into the main frame and/or the division frame, which is adjacent to the bent coupling portion, are coupled to each other by screws or bolts.

8. The window system as set forth in claim 6, wherein a coupling piece having support parts to be brought into close contact with respective adjacent frames is provided in a coupling region between the main frame and the division frame and/or between division frames; and the support parts of the coupling piece are coupled to the respective frames using screws or bolts.

9. The window system as set forth in claim 1, wherein a window sash, in which an openable window and/or a fixed window is installed, is integrally coupled in the window space.

10. The window system as set forth in claim 9, wherein the openable window is opened and closed through tilting and/or turning.
